(19) United States
(12) Patent Application Publication
(10) Pub. No.: US 2012/0036956 A1
(43) Pub. Date: Feb. 16, 2012

(54) Control Lever Unit for a Construction Machine and Construction Machine Having Such a Control Lever Unit

(75) Inventors: Thomas Klein, Wehr (DE); Thomas Haubrich, Goedenroth (DE)

(73) Assignee: BOMAG GMBH, Boppard (DE)

(21) Appl. No.: 13/025,986

(22) Filed: Feb. 11, 2011

(30) Foreign Application Priority Data
Feb. 11, 2010 (DE) 102010007608.2

(51) Int. Cl. G05G 9/00

(52) U.S. Cl. 74/471 R

(57) ABSTRACT

A control lever unit for controlling the driving and braking functions of a construction machine is provided. The control lever unit has a manual control lever actuatable by hand, this manual control lever having a hand rest surface, which renders possible the passive resting of the hand during operation. A construction machine, in particular a material compaction device, including at least one such control lever unit, is also contemplated.

### CROSS-REFERENCE TO RELATED APPLICATIONS

This application claims priority to foreign Patent Application DE 10 2010 007608.2, filed on Feb. 11, 2010, the disclosure of which is incorporated herein by reference in its entirety.

### FIELD OF THE INVENTION

The invention relates to a control lever unit for controlling the driving and braking function of a construction machine, this control lever unit having at least one manual control lever that can be actuated by hand. Furthermore, the invention relates to a construction machine, in particular a material compaction device used in the fields of construction or refuse compaction, having at least one such control lever unit.

### BACKGROUND OF THE INVENTION

Control levers are known in the art.

### SUMMARY OF THE INVENTION

Embodiments of the present invention advantageously improve known control lever units, particularly from an ergonomic standpoint.

These advantages are achieved by a control lever unit having a manual control lever actuatable by hand, the manual control lever having a hand rest surface, which renders possible a passive resting of the hand, wherein the hand rest surface is configured as a saddle-shaped free-form surface adapted to the inner surface of hand, is inclined in space and has an angle of inclination between 20° and 40°, preferably between 25° and 35°, and particularly approximately 30° in relation to a horizontal plane, and merges into a pommel, which is used for thumb support, and a cantle, which makes it more difficult for the hand to slip off. Embodiments of the invention also refer to a construction machine having at least one control lever unit. Such a construction machine is a material compaction device such as e.g. a roller with a driver's cab.

To achieve the above advantages, a control lever unit for controlling the driving and braking functions of a construction machine is provided, the control lever unit having at least one manual control lever that can be actuated by hand, this manual control lever having a hand rest surface that renders possible the passive resting of the hand during operation.

“Passive resting” is understood to mean that the weight of the hand is essentially completely supported, i.e. the hand can rest on the hand rest surface in such a manner that the operator does not have to exert muscular strength to hold the lever, as is the case in the manual control levers known from the prior art without a corresponding hand rest surface. A hand rest surface is understood as a planar area on the manual control lever, on which the inner surface of the operator's hand, at least essentially the palm, can be placed so that its weight is supported. A hand rest surface in the sense of the invention is thus to be differentiated from a simple hand contact surface, which does not support of the weight of a hand. As a result, in particular a comfortable and fatigue-free operation of the control lever unit is rendered possible according to the invention.

The control lever unit according to embodiments of the invention can comprise further components such as e.g. switch elements and in particular buttons for controlling auxiliary functions or a transmitter unit for converting the control movements into control signals. Furthermore, it may comprise shock absorption elements, fastening means, seal elements, etc.

According to one preferred embodiment, the hand rest surface is designed as a saddle-shaped, free-form surface adapted to the inner surface of a hand. The saddle-shaped design is characterized by a ridge line, from both sides of which two surface areas slope away. The ridge line can be linear or curved. A free-form surface is understood as a complex surface with multiple curves in space. The adaptation to the inner surface of a hand is based in particular on a so-called standard hand. Additionally, the possibility of individual adaptation also exists.

According to one preferred embodiment, the hand rest surface is inclined in space and has an angle of inclination between 20° and 40°, preferably between 25° and 35° and in particular approximately 30° in relation to a horizontal plane. At the specified angles of inclination, outstanding weight support and anti-slip characteristics are ensured for the hand placed or resting on the lever. The angle of inclination can be specified in particular as an angle of inclination of a ridge line relative to a horizontal plane. The specified angle measurements are relative to a neutral position of the manual control lever.

According to one preferred embodiment, the saddle-shaped hand rest surface, which is also inclined in space, merges into (or is limited by) a pommel, which is adapted in particular as a knob-like elevation and which is used for thumb contact and in particular for thumb support. Furthermore, the saddle-shaped hand rest surface, which is inclined in space, merges into (or is limited by) a cantle, which is adapted in particular as a bulge-shaped elevation to prevent a hand resting on the lever from slipping off or at least in order to render this more difficult. The actual saddle-shaped hand rest surface extends between the pommel and the cantle. This design is approximately suggestive of a riding saddle. The operating hand can be placed in a relaxed and ergonomic manner between the pommel and the cantle. The terms “pommel” and “cantle” are also derived from the terms for the corresponding parts of a riding saddle.

According to one preferred embodiment, at least one button for an auxiliary function of the construction machine is provided on the manual control lever, the at least one button being arranged on the pommel and actuatable by means of the thumb of the hand placed or resting on the lever. Such a button is preferably an electrical button such as a push button, a flip switch, or the like. Further diverse auxiliary functions that can be controlled by means of the button are named below.

According to one preferred embodiment, multiple buttons that can be actuated by means of the thumb, in particular four buttons, are provided for auxiliary functions. These buttons are arranged on the pommel along an arc section corresponding to the arc of motion of the thumb when a hand is resting on the lever. The control of multiple auxiliary functions can thus be effected in an ergonomically expedient manner.

According to one preferred embodiment, at least one button that can be actuated by means of a finger (not the thumb) is provided for an auxiliary function of the construction machine, the at least one button being arranged on the bottom side of the manual control lever. The above statements apply analogously to this button. This bottom side of the manual control lever can be accessed naturally by a finger as this area is designed to correspond to the natural curvature of a finger in e.g. a gripping motion. The relevant button is arranged so that it can be actuated by the actuating finger, the button being within the natural range of motion of a finger when a hand rests upon the lever. This is also in keeping with ergonomic principles.

According to one preferred embodiment, several buttons—in particular four buttons—that are actuatable by means of a finger (not the thumb) are provided for auxiliary functions, the several buttons being arranged on the bottom side of the manual control lever. The buttons are preferably arranged so that they are assigned to a specific finger (index finger, middle finger, ring finger and little finger) and, as they are respectively within an anatomical range of motion of the fingers when a hand is placed or resting on the lever, may readily be actuated by the individual fingers. The buttons are preferably situated along a straight line in this case.

According to one preferred embodiment, the control lever unit according to the invention is adapted for a right-handed operator or for a left-handed operator.

### BRIEF DESCRIPTION OF THE DRAWINGS

FIG. 1 shows a front view of a control lever unit according to an embodiment of the invention, and

FIG. 2 shows a rear view of the control lever unit depicted in FIG. 1.

### DETAILED DESCRIPTION

The invention will now be described with reference to the drawing figures, in which like reference numerals refer to like parts throughout.

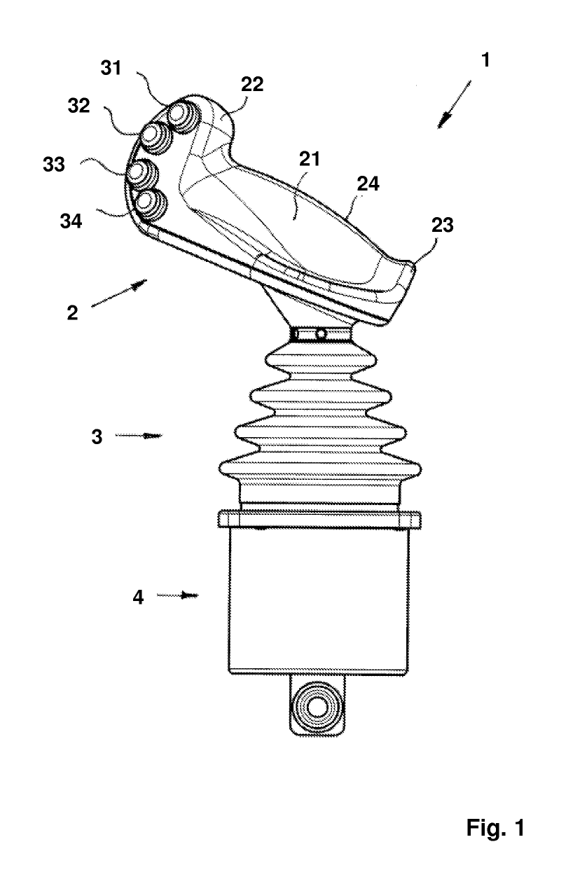

FIG. 1 shows a control lever unit 1 for controlling the driving and braking functions of a construction machine according to the invention. The example shown is designed for a right-handed operator, i.e. the lever is designed for operation by means of a right hand. The control lever unit 1 comprises a manual control lever 2, shown in a neutral position, and a transmission mechanism 3, which is covered by a folding bellows, and an encapsulated transmitter unit 4, for converting the manual control movements on the manual control lever 2 into corresponding control signals for the driving and braking functions. In a preferred arrangement inside the driver's cab of a construction machine, this control lever unit 1 is arranged to the right of the operator. In accordance with the illustration shown in FIG. 1, the manual control lever 2 can be operated directly by placing or resting the right hand on it.

The manual control lever 2 has a hand rest surface 21 adapted as a free-form surface that is adapted to the inner surface of a hand and extends in the shape of a saddle between an upper, knob-like pommel 22 and a lower, bulge-shaped cantle 23. The lower, bulge-shaped cantle 23 runs into the lower front edge of the hand rest surface 21. Designated by 24 and arching slightly upwards, the ridge line of the saddle-shaped hand rest surface 21 has an angle of inclination of approximately 30° in relation to the horizontal plane.

The hand rest surface 21 adapted between the pommel 22 and the cantle 23 renders possible the passive resting of the hand during operation, the weight of the hand being essentially completely supported. The thumb of the hand resting on the lever can touch or be placed or rested on the pommel 22. The bulge-shaped cantle 23 prevents the hand from slipping off of the inclined hand rest surface 21. The entire surface of the manual control lever 2, at least the surface transitions in the area of the hand rest surface 21, in particular toward the pommel 22 and the cantle 23, are adapted with a constant and smooth curvature in an ergonomic manner. The surface of the manual control lever 2 is formed by a coating, for example, a plastic film with an underlying foam layer.

Four buttons 31 to 34 that are actuatable by means of the thumb of the hand resting on the lever are adapted as push buttons and arranged along an arc section arranged on the pommel 22, the arc section corresponding to the arc of motion of the thumb. Each of these buttons 31 to 34 can be actuated comfortably by means of the thumb of the hand resting on the hand rest surface 21. Diverse auxiliary functions of the construction machine may be controlled via the buttons 31 to 34, as explained in greater detail below.

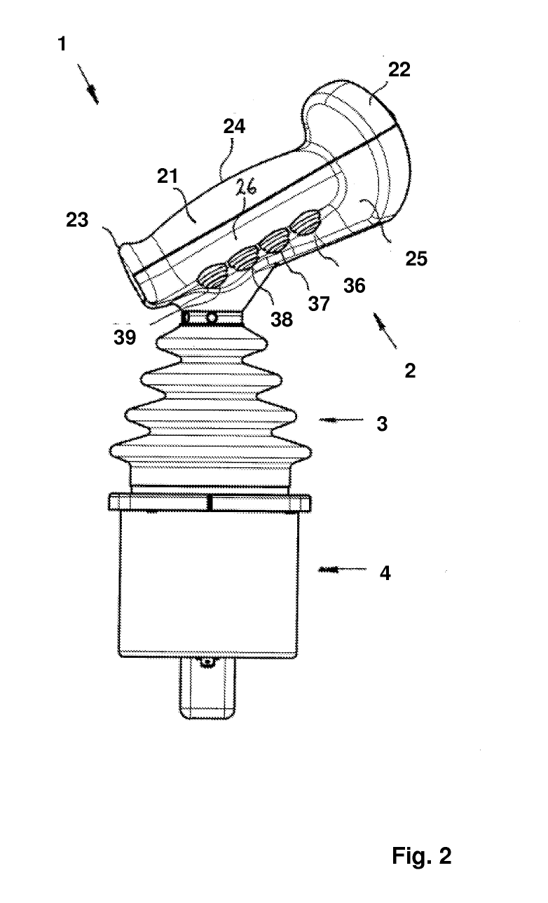

FIG. 2 shows a rear view of the control lever unit 1. As is evident from this rear view, the manual control lever 2 has a bottom side 26, which is accessible for the fingers of the (right) hand resting on the lever in an anatomically normal gripping motion. The pommel 22 continues on the bottom side 26 of the manual control lever 2; this continuation is adapted as a finger guide 25 for the index finger (of the right hand resting on the lever). Four buttons 36 to 39 that can each be actuated by means of a finger (index finger, middle finger, ring finger and little finger) are arranged on the bottom side 26; these buttons are also adapted as push buttons and can be actuated by means of the individual fingers in their respective anatomical direction of motion when the hand is resting on the lever. The buttons 36 to 39 are arranged along a straight line, which is not evident in the illustration shown. Diverse auxiliary functions may be controlled by means of the buttons 35 to 39, as explained in greater detail below.

Buttons 31 to 34, which can be actuated by the thumb of the resting hand, and buttons 36 to 39, which can be actuated by the fingers of the resting hand, render possible the execution of additional control functions (auxiliary functions) of the construction machine without the position of the resting hand having to be changed relative to the manual control lever 2.

Preferably, each of the buttons 31 to 34 and 36 to 39 has a specific auxiliary function assigned to it. The button configuration is selected here so that an intuitive actuation is possible, whereby greater safety and a reduction of incorrect operations are achieved. The buttons 31 to 34 and 36 to 39 may additionally be coded by different colors. All buttons 31 to 34 and 36 to 39 are adapted to correspond to the range of motion of the fingers (including the thumb).

For example, a particularly preferred configuration for the buttons 31 to 34 and 36 to 39 shown in the Table 1 can be selected for a tandem roller.

TABLE 1

| Button | | Actuation | |
|---|---|---|---|
| Number | Color | by Means of | Auxiliary Function |
| 31 | red | thumb | vibration |
| 32 | green | thumb | edge pressing and cutting |
| | | | equipment/chip spreader up |
| 33 | green | thumb | edge pressing and cutting |
| | | | equipment/chip spreader down |
| 34 | orange | thumb | signal horn |
| 36 | blue | index finger | chip spreader left/ |
| | | | crab steering left |
| 37 | blue | middle finger | chip spreader right/ |
| | | | crab steering right |
| 38 | yellow | ring finger | LCD software maneuvering |
| 39 | yellow | little finger | LCD software maneuvering |

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A control lever unit for controlling the driving and braking functions of a construction machine, comprising:
a manual control lever, actuatable by hand, having a hand rest surface which renders possible a passive resting of the hand,
wherein the hand rest surface is configured as a saddle-shaped free-form surface adapted to the inner surface of hand, is inclined in space and has an angle of inclination between 20° and 40° in relation to a horizontal plane, and merges into a pommel, which is used for thumb support, and a cantle, which makes it more difficult for the hand to slip off.

2. The control lever unit according to claim 1, wherein the manual control lever has at least one button arranged on the pommel and actuatable by means of the thumb for an auxiliary function.

3. The control lever unit according to claim 2, wherein four buttons, actuatable by means of the thumb are arranged on the pommel for auxiliary functions, the buttons being arranged along an arc section corresponding to the arc of motion of the thumb.

4. The control lever unit according to claim 1, wherein at least one button actuatable by means of a finger for an auxiliary function is arranged on the bottom side of the manual control lever.

5. The control lever unit according to claim 4, wherein four buttons actuatable by means of a finger are arranged on the bottom side of the manual control lever for auxiliary functions.

6. The control lever unit according to claim 1, wherein the control lever unit is adapted for use by right-handed operators or for use by left-handed operators.

7. The control lever unit according to claim 1, wherein the angle of inclination is between 25° and 35° in relation to a horizontal plane.

8. The control lever unit according to claim 7, wherein the angle of inclination is 30° in relation to a horizontal plane.

9. A construction machine including at least one control lever unit according to claim 1.

10. The construction machine according to claim 9, wherein the construction machine is a material compaction device.
